(19) United States
(12) Patent Application Publication
(10) Pub. No.: US 2024/0094992 A1
(43) Pub. Date: Mar. 21, 2024

(54) NON-DISRUPTIVE SERVICING COMPONENTS OF A USER MODE PROCESS

(71) Applicant: Microsoft Technology Licensing, LLC, Redmond, WA (US)

(72) Inventors: Robert Tyler RETZLAFF, Kirkland, WA (US); Omar CARDONA, Bellevue, WA (US); Jie ZHOU, Kirkland, WA (US); Dmitry MALLOY, Redmond, WA (US)

(73) Assignee: Microsoft Technology Licensing, LLC, Redmond, WA (US)

(21) Appl. No.: 17/932,872

(22) Filed: Sep. 16, 2022

(51) Int. Cl. G06F 8/10; G06F 8/70

(52) U.S. Cl. CPC G06F 8/10; G06F 8/70

(57) ABSTRACT

Examples of the present disclosure describe systems and methods for the non-disruptive servicing of components of a user mode process. In examples, a user mode process comprises multiple components, each encapsulating a distinct piece of functionality. A replacement component is loaded and initialized. The replacement component is validated to ensure that the required dependencies of the replacement component are satisfied by the other components of the user mode process. The component to be serviced and the components having dependencies on the component to be serviced are suspended to enable a snapshot of the runtime state of the component to be serviced to be captured. The runtime state is copied to the replacement component and the components having dependencies on the component to be serviced are updated to reference the replacement component. The replacement component is executed and the suspended components are resumed. The component to be serviced is unloaded.

### BACKGROUND

Computer operating systems generally implement a privileged mode and an unprivileged mode. When a process executing in the privileged mode needs to be serviced, the entire operating system executing the process needs to be restarted to facilitate the servicing. When a process executing in the unprivileged mode needs to be serviced, the process (and in some cases, the entire operating system) needs to be restarted to facilitate the servicing. In both cases, the servicing is disruptive to at least the process.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for the non-disruptive servicing of components of a user mode process. In examples, a user mode process comprises multiple components, each encapsulating a distinct piece of functionality. In order to non-disruptively service a component, a replacement component is loaded and initialized. The replacement component is validated to ensure that the required dependencies of the replacement component are satisfied by the other components of the user mode process, and to ensure that components having dependencies on the component to be serviced are satisfied by the replacement component. The component to be serviced and the components having dependencies on the component to be serviced are suspended to enable a snapshot of the runtime state of the component to be serviced to be captured. The runtime state of the component to be serviced is copied to the replacement component and the components having dependencies on the component to be serviced are updated to reference the replacement component. The replacement component is updated to satisfy its dependencies on the other components of the process. The replacement component is resumed and the components previously suspended to capture the snapshot of the runtime state of the component to be serviced are resumed. The component to be serviced is then unloaded

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an example computing device for the non-disruptive servicing of components of a user mode process.

FIGS. 2A-2D illustrate an example process for non-disruptive servicing of components.

FIG. 3 illustrates an example method for the non-disruptive servicing of components of a user space process.

FIG. 4 is a block diagram illustrating example physical components of a computing device for practicing aspects of the disclosure.

FIGS. 5A and 5B are simplified block diagrams of an example mobile computing device for practicing aspects of the present disclosure.

FIG. 6 is a simplified block diagram of an example distributed computing system for practicing aspects of the present disclosure.

### DETAILED DESCRIPTION

A computer operating system (OS) generally implements a privileged mode, such as a kernel mode, and an unprivileged mode, such as a user mode. Although components (e.g., software components) executing in kernel mode are able to access underlying hardware resources of the OS and experience reduced operations latency as compared to user mode, executing components in kernel mode often decreases the overall availability of the OS. As one example, when a component executing in kernel mode fails, the entire OS fails and must be restarted. As another example, when a component executing in kernel mode needs to be serviced, the OS must be halted and restarted. When a component executing in user mode fails or needs to be serviced, a process to which the component belongs (and in some cases the OS) fails and must be restarted. In both scenarios, the runtime state of the components is lost when the process or OS is restarted. Accordingly, any calls made by or provided to the components or operations being performed by the component when the OS is restarted are unrecoverable. A call, as used here, refers to a programmatic statement that requests services from a subroutine, a program, or a system. The unrecoverable calls and operations can introduce instability to the OS, result in lost or corrupted data, and severely diminish the user experience.

The present disclosure provides a solution that enables the non-disruptive (or minimally disruptive) servicing of components of a user mode process. In embodiments of the present disclosure, a process executing in user mode (“user mode process”) comprises multiple components. A component is a portion of software for performing specific functionality, such as a software library, a code segment, or another type of executable file. In order to non-disruptively service a component of the user mode process (“component to be serviced”), a component intended to replace the component to be serviced (“replacement component”) is loaded and initialized for the user mode process. In examples, a component may be serviced for various reasons, such as defect correction, performance enhancements, and feature additions.

The replacement component is validated to ensure that the required software dependencies of the replacement component are satisfied by the other components of the user mode process. A software dependency, as used herein, refers to software (e.g., a code library, a software package, an object, an interface) that is relied on by one component to perform certain functionality of another component. Validating the replacement component also ensures that components of the user mode process that have dependencies on the component to be serviced (“dependent components”) are satisfied by the replacement component. In a specific example, the component to be serviced, the replacement component, and one or more of the dependent components are dynamic link library (DLL) files.

The component to be serviced and the dependent components are then suspended such that neither the component to be serviced nor the dependent components can perform operations that would further alter their respective runtime states. Upon (or prior to) suspending the components, a snapshot of the runtime state of the component to be serviced is captured. A snapshot, as used herein, refers to a saved copy of a current memory state of a component or a set of components. The runtime state represents the current execution state of a component and may include pending calls sent to or received from software and hardware components, currently executing processes or operations, pointers to memory addresses, and the like. The runtime state of the component to be serviced is copied to the replacement component and the dependent components are updated to reference the replacement component. In examples, updating the dependent components comprises replacing references in the dependent components to the component to be serviced with references to the replacement component.

The replacement component is updated to satisfy dependencies on other components of the user mode process. For example, as the dependent components have dependencies on the replacement component, the replacement component may have dependencies on other components of the user mode process. The replacement component is executed and the components previously suspended to capture the snapshot of the runtime state of the component to be serviced are resumed. In some embodiments, the component to be serviced is then unloaded from the user mode process at some subsequent point in time. In examples, the subsequent point in time may be immediately after the replacement component is executed.

Accordingly, the present disclosure provides a plurality of technical benefits and improvements over previous component servicing solutions. These technical benefits and improvements include: enabling servicing of components of a process such that only a subset of the overall functionality of the process is disrupted while allowing other functionality of the process to continue, and dynamically validating component dependencies during component servicing, among others.

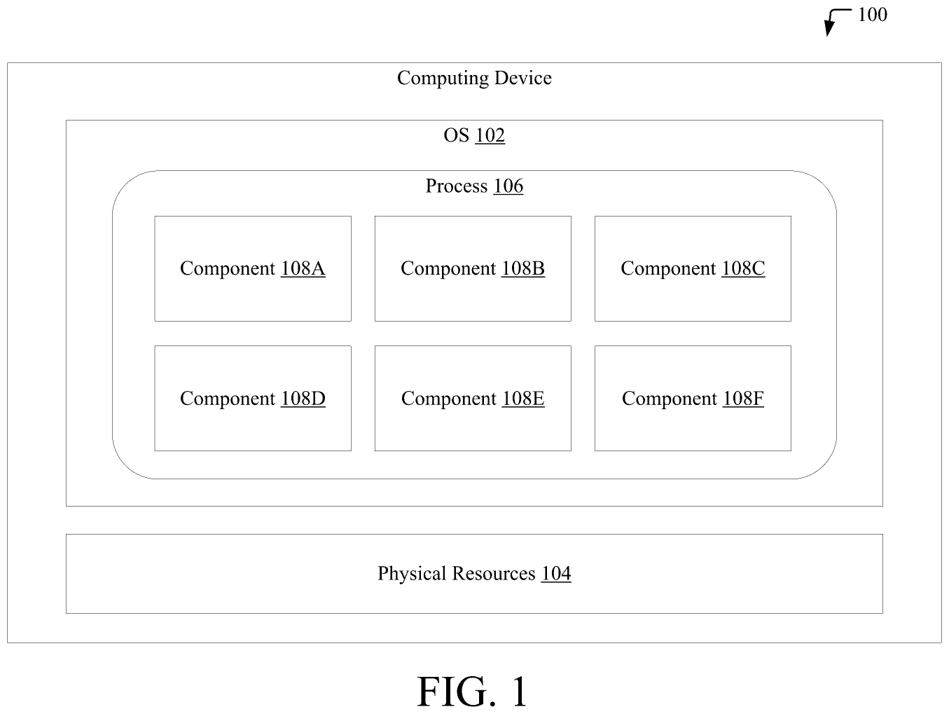

FIG. 1 illustrates a computing device for the non-disruptive servicing of components of a user mode process. Example computing device 100 as presented is a combination of interdependent components that interact to form an integrated whole. Components of computing device 100 may be hardware components or software components (e.g., APIs, modules, runtime libraries) implemented on and/or executed by hardware components of computing device 100. In one example, components of computing device 100 are distributed across multiple processing devices or computing systems.

In FIG. 1, computing device 100 comprises OS 102 and physical resources 104. OS 102 comprises process 106. Process 106 comprises components 108A, 108B, 108C, 108D, 108E, and 108F (collectively referred to as “component(s) 108”). The scale and structure of devices and environments discussed herein may vary and may include additional or fewer components than those described in FIG. 1 and subsequent figures. Further, although examples in FIG. 1 and subsequent figures will be discussed in the context of servicing components of a user mode process, the examples are equally applicable to other contexts, such as servicing components of a kernel mode process. Examples of computing device 100 include personal computers (PCs), server devices, mobile devices (e.g., smartphones, tablets, laptops, personal digital assistants (PDAs)), wearable devices (e.g., smart watches, smart eyewear, fitness trackers, smart clothing, body-mounted devices, head-mounted displays), gaming consoles or devices, and Internet of Things (IoT) devices.

OS 102 receives input data (e.g., audio input, touch input, text-based input, gesture input, and/or image input) from a user or another computing device. In some examples, the input data corresponds to user interaction with process 106. In other examples, the input data corresponds to automated interaction with process 106, such as the automatic (e.g., non-manual) execution of scripts or sets of commands at scheduled times or in response to predetermined events. OS 102 implements a user mode and a kernel mode for executing software, such as process 106 and component(s) 108, and controlling peripherals (e.g., microphones, touch-based sensors, geolocation sensors, accelerometers, optical/magnetic sensors, gyroscopes, keyboards, and pointing/selection tools).

Physical resources 104 include processing hardware (e.g., CPUs, graphics processing units (GPUs), video cards), memory, persistent storage, network interfaces, and the like. In examples, physical resources 104 are directly accessible by OS 102 and components executing in kernel mode of OS 102, but are not directly accessible by components executing in user mode of OS 102. In such examples, components executing in user mode of OS 102 indirectly access physical resources 104 via components executing in kernel mode of OS 102 or via a component of computing device 100, such as a hypervisor.

Process 106 is an instance of a program executing on computing device 100. Process 106 is executed using physical resources 104 and may be implemented as a user mode process or a kernel mode process. In examples, process 106 comprises a set of components, such as component(s) 108. Component(s) 108 perform various operations and provide access to a set of software and/or hardware functionality, such as control path management, core data processing, extended data processing, and other such functionality. In examples, component(s) 108 send and receive calls to/from other user mode components and kernel mode components of OS 102. Component(s) 108 also send and receive calls to/from components external to OS 102. For instance, component(s) 108 may interact with the components on another device via a network, such as a private area network (PAN), a local area network (LAN), or a wide area network (WAN). Component(s) 108 may indicate software dependencies for other components. As one example, component 108A may indicate a software dependency for component 108B, which may indicate software dependencies for component 108C and component 108D. Examples of component(s) 108 include software libraries, functions, methods, code segments, applications, services, and the like.

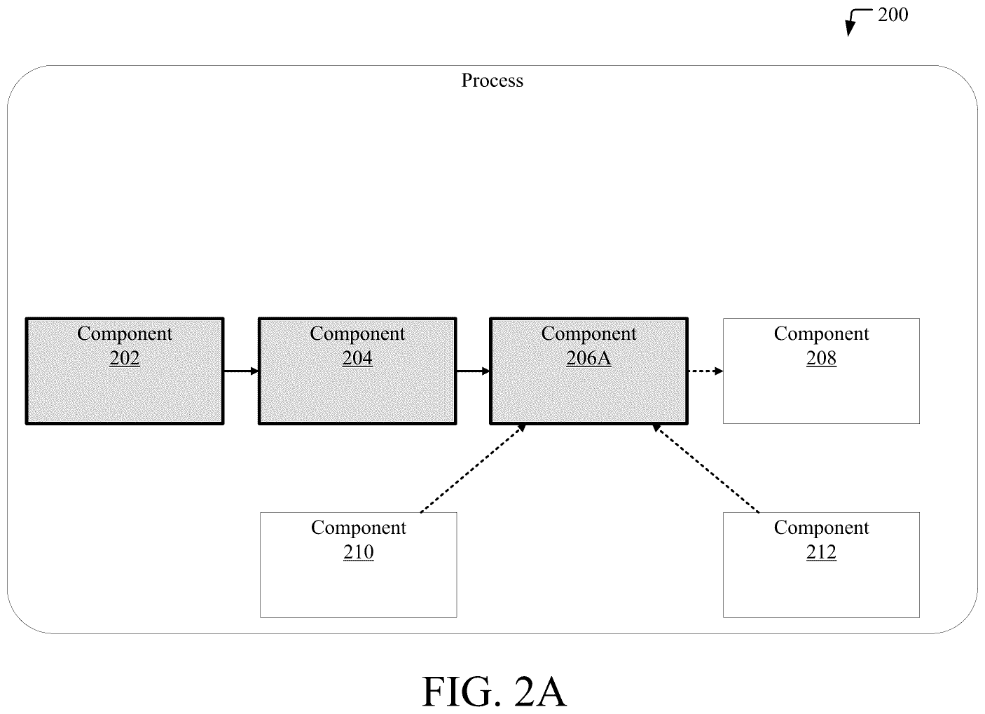

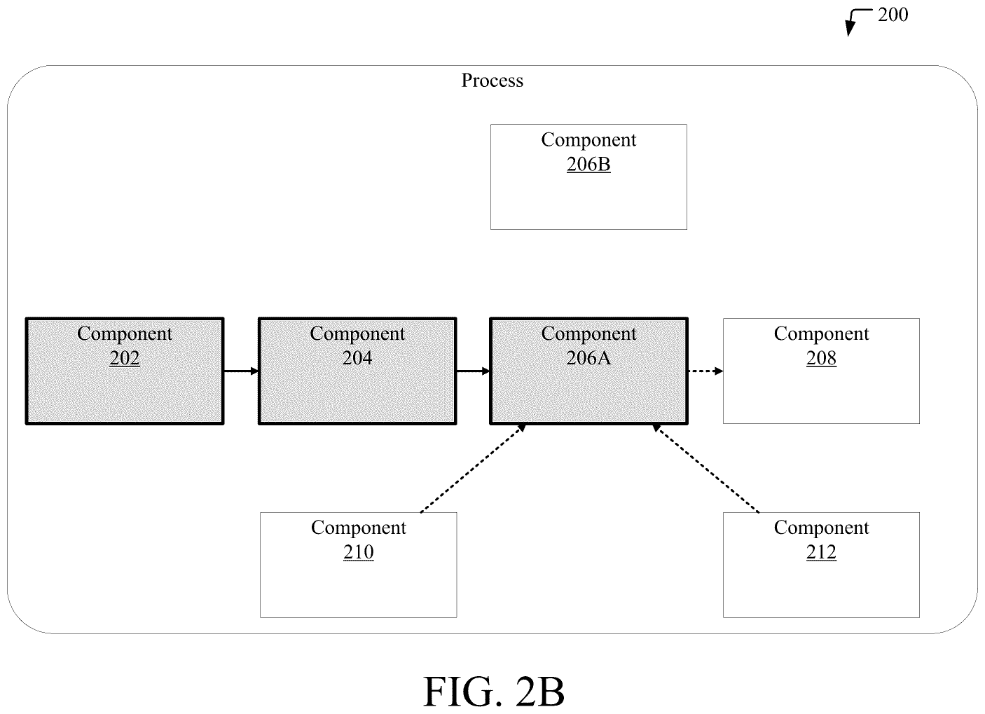

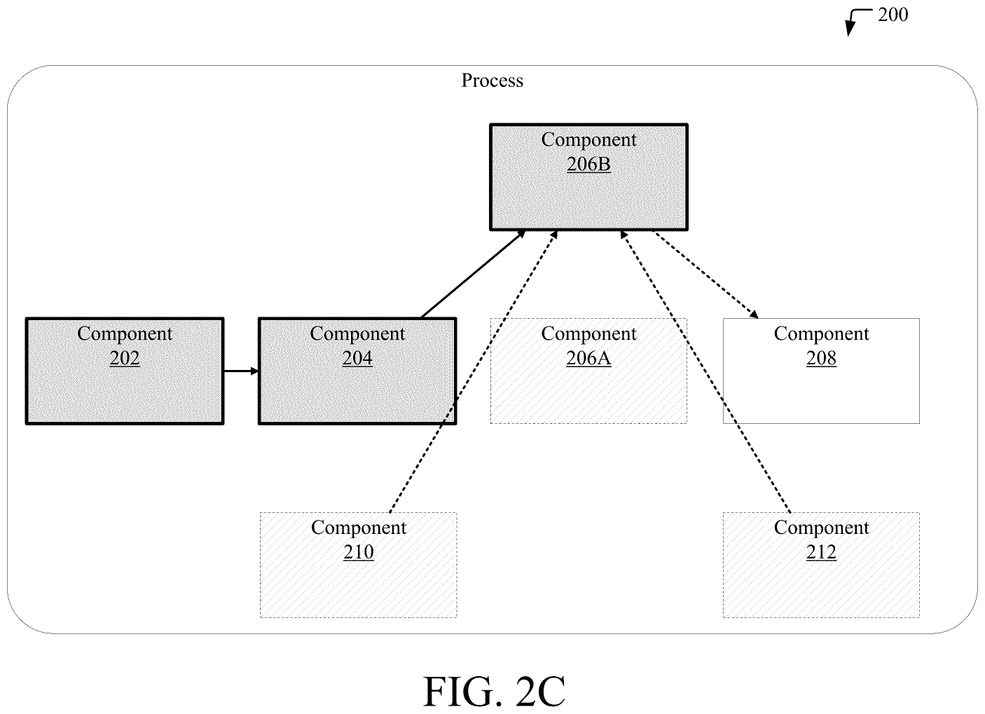

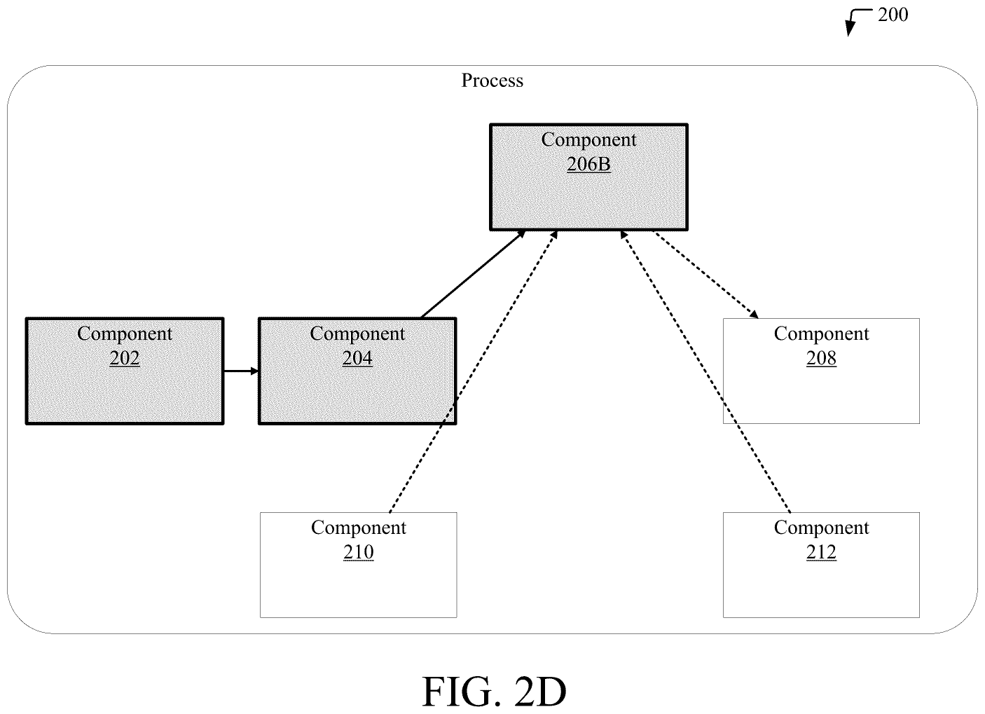

FIGS. 2A-2D illustrate an example process for which non-disruptive servicing of components of the process is performed. FIG. 2A illustrates a user mode process prior to servicing a component to be serviced. FIG. 2B illustrates the user mode process after loading a replacement component for the user mode process. FIG. 2C illustrates the user mode process after executing the replacement component. FIG. 2D illustrates the user mode process after unloading the component to be serviced from the user mode process.

In FIG. 2A, example process 200 comprises components 202, 204, 206A, 208, 210, and 212. Components 202-212 are implemented as user mode components of process 200. The process execution path comprises components 202, 204, and 206A and is denoted by the bolded border lines and interior shading of components 202, 204, and 206A. The process execution path begins at component 202 and ends at component 206A. As one example, a data request may be received by component 202 or provided to component 202. Component 202 processes the data request. Processing the data request may include providing output to component 204 or invoking component 204. Component 204 performs further processing related to the data request and provides output to or invokes component 206A. After performing further processing related to the data request, component 206A completes the data request. Completing the data request may include executing software or hardware functionality or providing a response to a component or a user.

Component 206A comprises a software dependency on component 208, denoted by the dotted arrow pointing towards component 208. For example, component 208 may be a DLL file that component 206A calls when component 206A is executed. Components 210 and 212 comprise software dependencies on component 206A, denoted by the dotted arrows pointing towards component 206A.

In FIG. 2B, component 206B is loaded to process 200. Component 206B replicates the functionality of component 206A and is intended as a replacement for component 206A. Loading component 206B does not cause process 200 or the components executing in process 200 to halt or to be restarted. The process execution path continues to comprise components 202, 204, and 206A.

In FIG. 2C, component 206B has been implemented in process 200, component 206A has been suspended, and components 210 and 212 have been suspended based on their dependencies on component 206A. The suspensions of components 206A, 210, and 212 are denoted by the dashed border lines and interior striping applied to each component. Implementing component 206B comprises, among other things, updating the software dependencies of component 206A to refer to component 206B. For example, component 206B now comprises a software dependency on component 208, denoted by the dotted arrow pointing towards component 208, and components 210 and 212 now comprise software dependencies on component 206B, denoted by the dotted arrows pointing towards component 206B. Implementing component 206B also comprises applying a runtime state of component 206A (obtained prior to or when suspending component 206A, or while component 206A is suspended) to components 206B, then executing component 206B. Executing components 206B causes components 210 and 212 to resume from suspension and causes the process execution path to be modified such that component 206B replaces component 206A. For example, the process execution path now comprises components 202, 204, and 206B.

In FIG. 2C, although suspended, component 206A remains loaded in process 200. As such, the operations in FIGS. 2A-2C can be reversed to reimplement component 206A, without causing process 200 or a portion of the components executing in process 200 to halt or to be restarted. As one example, upon determining that component 206B has not been loaded correctly or is not functioning correctly (thereby preventing process 200 from executing correctly), the software dependencies of component 206B are reupdated to refer to component 206A. Component 206A is then resumed from suspension, such that the process execution path again comprises components 202, 204, and 206A.

In FIG. 2D, component 206A is unloaded from process 200. In examples, component 206A may be immediately unloaded from process 200 after component 206B is executed or unloaded from process 200 after an extended period of time has lapsed. After unloading component 206A, the process execution path continues to comprise components 202, 204, and 206B.

Having described one or more devices and environments that may employ aspects of the present disclosure, a method for performing these aspects will now be described. In examples, method 300 may be executed by a device, such as computing device 100. However, method 300 is not limited to such examples.

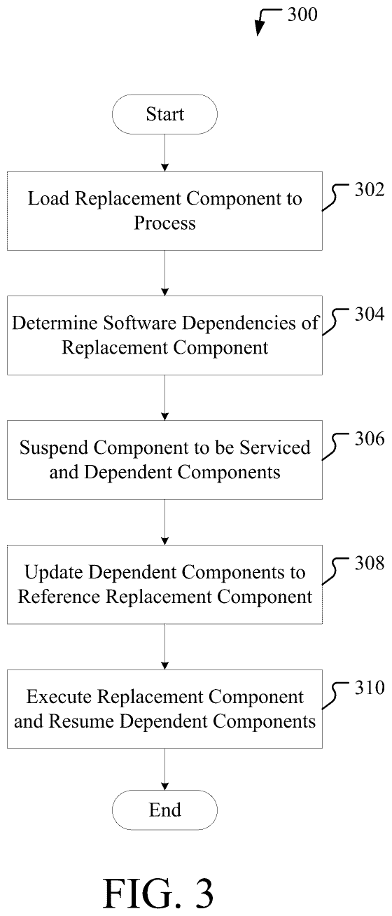

FIG. 3 illustrates an example method for the non-disruptive servicing of components of a user mode process. Example method 300 begins at operation 302, where a replacement component, such as component 206B, is loaded for a user mode process, such as process 200. At the time the replacement component is loaded for the process, the process comprises a currently loaded and executing component to be serviced, such as component 206A. In a specific example, the replacement component and the component to be serviced are DLLs. Loading the replacement component for the process comprises allocating memory for the replacement component (e.g., providing space on the stack or the heap) and initializing the replacement component (e.g., providing an initial value to one or more variables used in the replacement component). In examples, loading the replacement component for the process does not cause the process or at least a portion of the components executing in the process to be halted or restarted.

At operation 304, the replacement component is validated to ensure that the required software dependencies of the replacement component are satisfied by the other components of the process. Ensuring the required software dependencies of the replacement component are satisfied includes identifying direct software dependencies (e.g., software called directly by the replacement component) and transitive software dependencies (e.g., software called by the software dependencies of the replacement component) of the replacement component. In examples, the software dependencies of the replacement component may include some or all of the software dependencies of the component to be serviced. Validating the replacement component also comprises ensuring that components having dependencies on the component to be serviced (“dependent components”) are satisfied by the replacement component by identifying the direct and transitive software dependencies of the dependent components. In at least one example, a software management utility is used to determine the software dependencies of components.

At operation 306, the component to be serviced and the dependent components are suspended. Suspending the component to be serviced and the dependent components ensures that neither the component to be serviced nor the dependent components can perform operations that would further alter their respective runtime states or the runtime states of other components of the process. While the component to be serviced and the dependent components are suspended, other components of the process remain functional. Upon (or prior to) suspending the component to be serviced and the dependent components, a snapshot of the runtime state of the component to be serviced is captured. The current runtime state may include pending calls sent by the component to be serviced, pending calls received by the component to be serviced, currently executing processes or operations, pointers to memory addresses, status indicators, and contents of hardware registers. The snapshot is then copied to the replacement component such that the runtime state of the component to be serviced is applied to the replacement component. Applying the runtime state may comprise scheduling the execution of the pending calls sent and received by the component to be serviced at the time of the snapshot, scheduling the completion or re-execution of operations that were being performed by the component to be serviced at the time of the snapshot, and the like.

At operation 308, the dependent components are updated to reference the replacement component. Updating the dependent components comprises replacing references to the component to be serviced with a reference to the replacement component. For instance, the name or file path of the component to be serviced is replaced with the name or file path of the replacement component. In some examples, the replacement component is also updated to satisfy the replacement component's software dependencies on other components of the process. For instance, references in the component to be serviced to other components are copied to the replacement component. In at least one example, the component to be serviced is then unloaded from the process. Unloading the component to be serviced comprises deallocating resources previously allocated to the component to be serviced and removing the component to be serviced from memory. In another example, the component to be serviced is unloaded from the process at operation 310.

At operation 310, the replacement component is executed and the dependent components previously suspended to capture the snapshot of the runtime state of the component to be serviced are resumed. Executing the replacement component may comprise causing the replacement component to perform scheduled calls and operations and to perform new calls and operations. Accordingly, when the replacement component is executed and the dependent components are resumed, the component to be serviced has been serviced in a manner that is non-disruptive (or minimally disruptive) to the other components of the process.

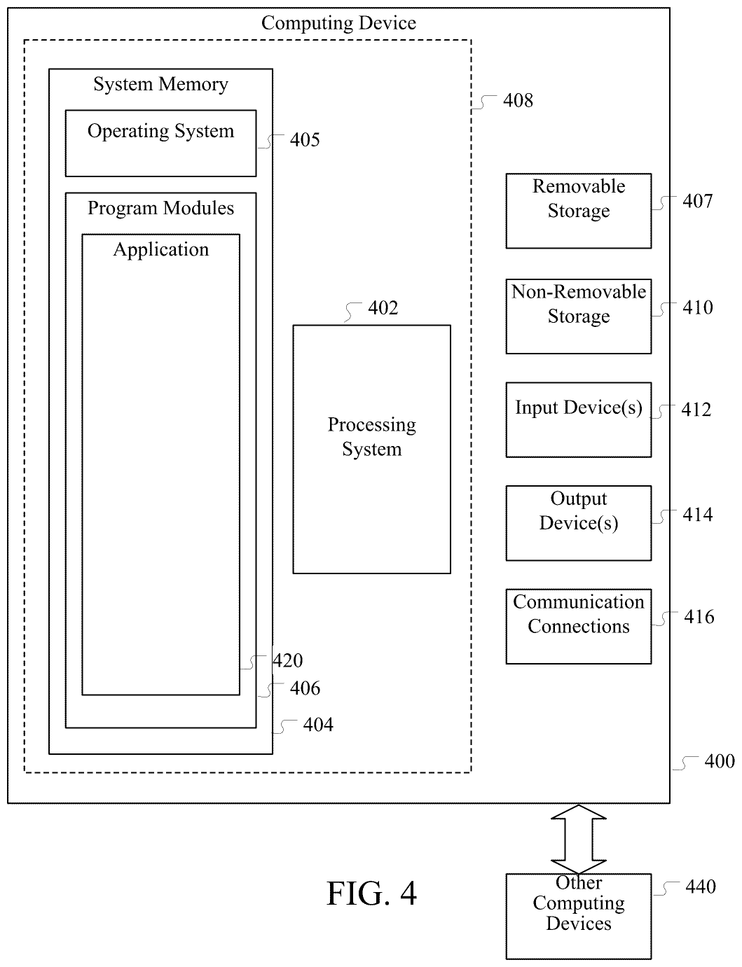

FIGS. 4-6 and the associated descriptions provide a discussion of a variety of operating environments in which aspects of the disclosure may be practiced. However, the devices and systems illustrated and discussed with respect to FIGS. 4-6 are for purposes of example and illustration, and, as is understood, a vast number of computing device configurations may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing devices and systems described above. In a basic configuration, the computing device 400 includes a processing system 402 comprising at least one processing unit and a system memory 404. Depending on the configuration and type of computing device, the system memory 404 may comprise volatile storage (e.g., random access memory), non-volatile storage (e.g., read-only memory), flash memory, or any combination of such memories.

The system memory 404 includes an operating system 405 and one or more program modules 406 suitable for running software application 420. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks or optical disks. Such additional storage is illustrated in FIG. 4 by a removable storage device 407 and a non-removable storage device 410.

As stated above, a number of program modules and data files may be stored in the system memory 404. While executing on the processing system 402, the program modules 406 (e.g., application 420) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 450. Examples of suitable communication connections 416 include radio frequency (RF) transmitter, receiver, and/or transceiver circuitry; universal serial bus (USB), parallel, and/or serial ports.

The term computer readable media as used herein includes computer storage media. Computer storage media includes volatile and nonvolatile, removable and non-removable media implemented in any method or technology for storage of information, such as computer readable instructions, data structures, or program modules. The system memory 404, the removable storage device 407, and the non-removable storage device 410 are all computer storage media examples (e.g., memory storage). Computer storage media includes random access memory (RAM), read-only memory (ROM), electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be encoded by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. By way of example, communication media may include wired media such as a wired network or direct-wired connection, and wireless media such as acoustic, RF, infrared, and other wireless media.

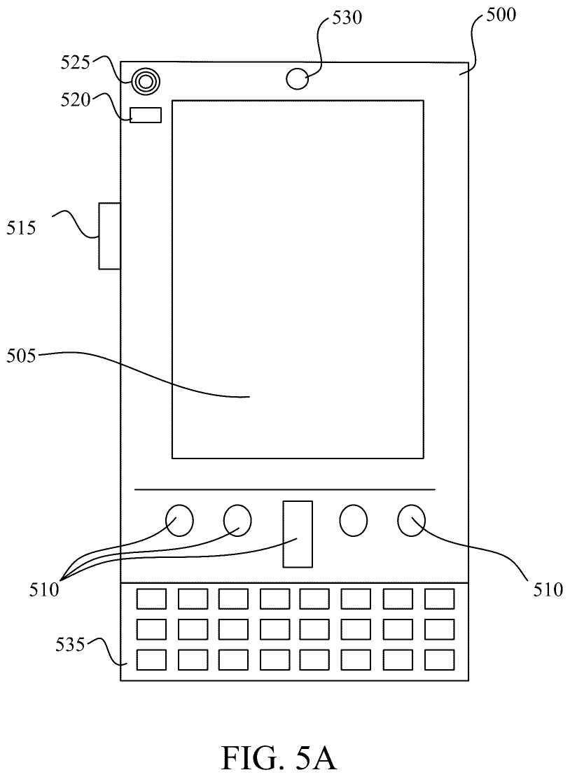

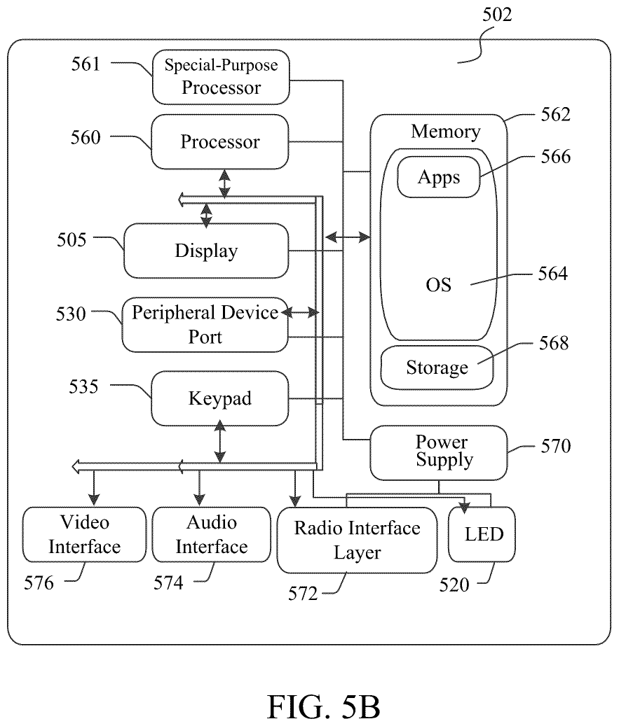

FIGS. 5A and 5B illustrate a mobile computing device 500, for example, a mobile telephone, a smart phone, wearable computer (such as a smart watch), a tablet computer, a laptop computer, and the like, with which embodiments of the disclosure may be practiced. In some aspects, the client is a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display).

If included, an optional side input element 515 allows further user input. The side input element 515 may be a rotary switch, a button, or any other type of manual input element. In alternative aspects, mobile computing device 500 incorporates more or less input elements. For example, the display 505 may not be a touch screen in some embodiments.

In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device 500 can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500 described herein (e.g., search engine, extractor module, relevancy ranking module, answer scoring module).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator (e.g., light emitting diode (LED)) 520 may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor(s) (e.g., processor 560 and/or special-purpose processor 561) and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of a peripheral device port 530 (e.g., an on-board camera) to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

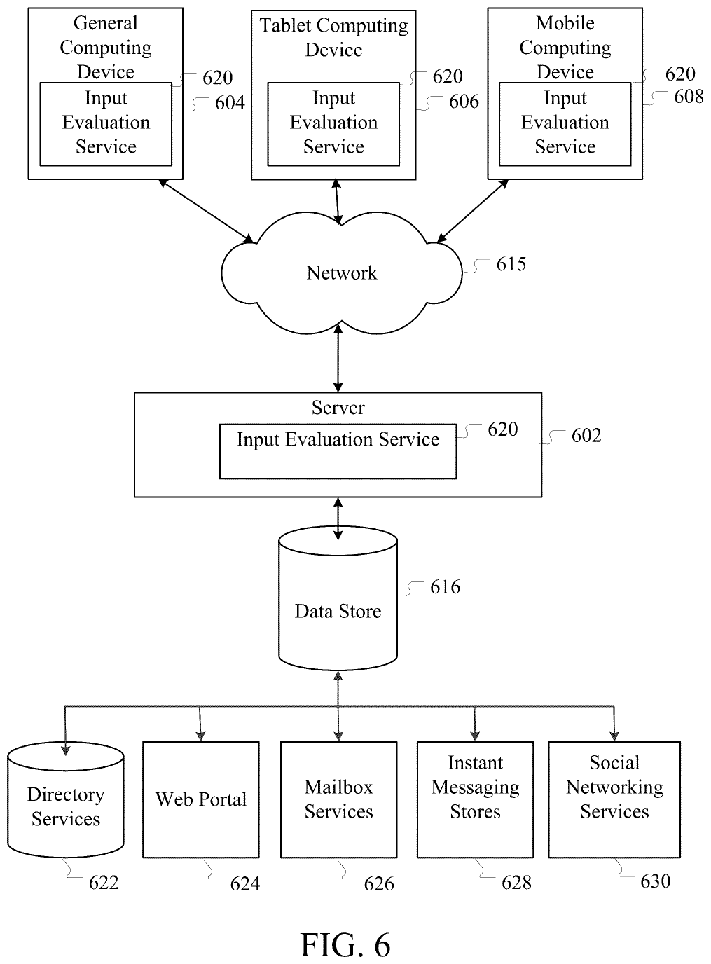

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using a directory service 622, a web portal 624, a mailbox service 626, an instant messaging store 628, or a social networking site 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the store 616, in addition to receiving graphical data useable to be either pre-processed at a graphic-originating system, or post-processed at a receiving computing system.

As will be understood from the present disclosure, one example of the technology discussed herein relates to a system comprising: a processing system; and memory coupled to the processing system, the memory comprising computer executable instructions that, when executed by the processing system, perform operations. The operations comprise: loading a replacement component for a user mode process, the user mode process comprising a component to be serviced and dependent components of the component to be serviced; validating software dependencies of the replacement component are satisfied; suspending the component to be serviced and the dependent components; updating the dependent components to reference the replacement component; and executing the replacement component and resuming the dependent components.

In another example, the technology discussed herein relates to a method comprising: loading, into memory, a first software component for use by a process in the memory, the process comprising a second software component, a software component dependent on the second software component, and a software component that is not dependent on the second software component; determining a runtime state of the second software component; suspending the second software component and the software component dependent on the second software component, wherein the software component that is not dependent on the second component remains functional when the second software component and the software component dependent on the second software component are suspended; modifying the software component dependent on the second software component to be a software component dependent on the first software component; applying the runtime state of the second software component to the first software component; and executing the first software component and the software component dependent on the first software component.

In another example, the technology discussed herein relates to a system comprising: memory having computer executable instructions that, when executed, perform operations. The operations comprising: loading first software for a process executing in the memory, the process comprising: second software; third software that is dependent on the second software; and fourth software that is not dependent on the second software; determining a runtime state of the second software; suspending the second software and the third software, wherein suspending the second software and the third software does not cause the fourth software to be suspended; updating the third software to reference the first software, wherein updating the third software causes the third software to be dependent on the first software; applying the runtime state of the second software to the first software; and executing the first software, wherein executing the first software causes the third software to resume from being suspended.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system comprising:
a processing system; and
memory coupled to the processing system, the memory comprising computer executable instructions that, when executed by the processing system, perform operations comprising:
loading a replacement component for a user mode process, the user mode process comprising a component to be serviced and dependent components of the component to be serviced;
validating software dependencies of the replacement component are satisfied;
creating a snapshot of a runtime state of the component to be serviced;
suspending the component to be serviced and the dependent components;
updating the dependent components to reference the replacement component; and
executing the replacement component and resuming the dependent components.

2. The system of claim 1, wherein loading the replacement component comprises:
allocating memory for the replacement component; and
initializing the replacement component, the initializing providing an initial value to a variable used by the replacement component.

3. The system of claim 1, wherein:
the user mode process further comprises a component that is not dependent on the component to be serviced; and
suspending the component to be serviced and the dependent components comprises suspending the component to be serviced and the dependent components without suspending the component that is not dependent on the component to be serviced.

4. The system of claim 1, wherein validating the software dependencies of the replacement component comprises:
identifying direct software dependencies of the replacement component; and
identifying transitive software dependencies of the replacement component.

5. The system of claim 4, wherein validating the software dependencies of the replacement component further comprises:
determining that the dependent components are satisfied by the replacement component by identifying direct software dependencies and transitive software dependencies of the dependent components.

6. The system of claim 1, wherein suspending the component to be serviced and the dependent components prevents the component to be serviced and the dependent components from performing operations that alter a respective runtime state of the component to be serviced and the dependent components.

7. The system of claim 1, wherein the snapshot represents a saved copy of a current memory state of the component to be serviced.

8. The system of claim 7, wherein the runtime state of the component to be serviced comprises at least one of:
calls sent by the component to be serviced;
calls received by the component to be serviced; or
operations currently being performed by the component to be serviced.

9. The system of claim 8, wherein the runtime state of the component to be serviced is applied to the replacement component.

10. The system of claim 9, wherein applying the runtime state of the component to be serviced to the replacement component comprises scheduling execution of at least one of:
calls sent by the component to be serviced;
calls received by the component to be serviced; or
the operations currently being performed by the component to be serviced.

11. The system of claim 10, wherein resuming the replacement component comprises causing execution by the replacement component of at least one of:
the calls sent by the component to be serviced;
the calls received by the component to be serviced; or
the operations currently being performed by the component to be serviced.

12. The system of claim 1, wherein updating the dependent components comprises replacing a reference to the component to be serviced with a reference to the replacement component.

13. The system of claim 12, wherein a reference to the component to be serviced corresponds to at least one of:
a name of the component to be serviced; or
a file path of the component to be serviced.

14. The system of claim 1, further comprising unloading the component to be serviced, the unloading comprises:
deallocating resources previously allocated to the component to be serviced; and
removing the component to be serviced from the memory.

15. A method comprising:
loading, into memory, a first software component for use by a process in the memory, the process comprising a second software component, a software component dependent on the second software component, and a software component that is not dependent on the second software component;
determining a runtime state of the second software component;
suspending the second software component and the software component dependent on the second software component, wherein the software component that is not dependent on the second component remains functional when the second software component and the software component dependent on the second software component are suspended;
modifying the software component dependent on the second software component to be a software component dependent on the first software component;
applying the runtime state of the second software component to the first software component; and
executing the first software component and the software component dependent on the first software component.

16. The method of claim 15, wherein the first software component is a first dynamic link library and the second software component is a second dynamic link library.

17. The method of claim 15, wherein modifying the software component dependent on the second software component comprises:
updating a reference to the second software component to a reference to the first software component.

18. The method of claim 15, wherein suspending the second software component and the software component dependent on the second software component comprises:
unloading the second software component from the memory, wherein unloading the second software component does not cause the process to be restarted.

19. The method of claim 15, wherein executing the first software component and the software component dependent on the first software component comprises:
causing the first software component to perform an operation associated with the process; and
causes the software component dependent on the first software component to resume from being suspended.

20. A system comprising:
memory having computer executable instructions that, when executed, perform operations comprising:
loading first software for a process executing in the memory, the process comprising:
second software;
third software that is dependent on the second software; and
fourth software that is not dependent on the second software;
determining a runtime state of the second software;
suspending the second software and the third software, wherein suspending the second software and the third software does not cause the fourth software to be suspended;
updating the third software to reference the first software, wherein updating the third software causes the third software to be dependent on the first software;
applying the runtime state of the second software to the first software; and
executing the first software, wherein executing the first software causes the third software to resume from being suspended.
